(19) United States
(12) Patent Application Publication
(10) Pub. No.: US 2011/0236664 A1
(43) Pub. Date: Sep. 29, 2011

(54) SHEET FOR PACKAGING FOOD

(76) Inventors: Silvia Ortolani, Vicenza (IT); Roberta Ortolani, Padova (IT)

(21) Appl. No.: 12/998,851

(22) PCT Filed: Dec. 11, 2009
(86) PCT No.: PCT/EP2009/066996

§ 371 Date: Jun. 8, 2011

(30) Foreign Application Priority Data
Dec. 15, 2008 (IT) PD2008A0000368

(51) Int. Cl. B32B 15/09; B32B 29/00; B32B 27/36; B32B 27/06; B32B 15/12

(52) U.S. Cl. 428/219; 428/459; 428/336; 428/340

(57) ABSTRACT

A sheet for packaging food, comprising

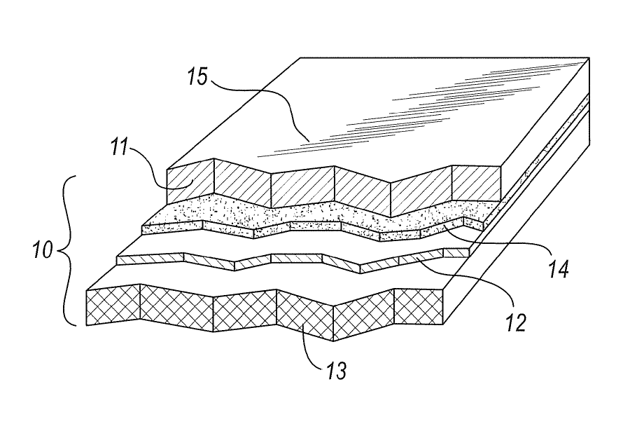

a first layer made of paper-like material,

a second intermediate layer made of metallic material,

a third layer made of plastic material, on which the second layer is deposited,

an adhesive layer between the first and second layers,

the third layer of which is constituted by a film of biodegradable and compostable plastic material adapted for contact with food.

### BACKGROUND OF THE INVENTION

Various types of sheet for packaging food which is sold loose by weight, such as salami, cheese, meat, bakery products and the like, are currently known.

Sheets of the type that comprises a first outer layer of paper coupled to a second inner layer made of polyethylene are widespread.

Characteristic, distinctive and ornamental markings are generally printed on the outer paper layer, while the polyethylene layer makes contact with the food for its best preservation.

Although these known types of sheet are used extensively, they have drawbacks.

For example, these sheets are unable to act as a barrier against light and the infrared, with important limitations for preservation of food whose decomposition is facilitated by light.

Other known sheets have a layer of paper on which a layer of aluminum, adapted to reflect light and the infrared, is deposited by means of a metallization operation.

However, these other sheets can be placed in contact with the food only by means of their non-metallized face, due to the concrete risk of migration of the metal toward the food.

In order to obviate these drawbacks, this same Applicant devised a sheet for packaging food, as described and claimed in EP 1584464; such sheet for packaging food is of the type that comprises a first paper layer coupled to a second polyethylene layer and is characterized in that a third metallic layer is deposited on said second polyethylene layer; such second layer is coupled to the first layer on the side of the third metallic layer by interposition of a fourth adhesive layer between the third and first layers, such fourth adhesive layer being based on vegetable starches and glucose.

The adhesive layer is such as to allow easy manual separation of the first paper layer on one side and of the second polyethylene layer with metallic layer on the other side, for better disposal of the waste.

Numerous studies and tests conducted on this sheet for packaging food have shown that if it is not sent to disposal after being separated into its components, i.e., the first paper layer on one side and the third polyethylene layer with metallic layer on the other side, but is sent intact to composting or to methods for the production of biomass for various uses (for example as an energy source), it is presumable that such sheet will degrade over relatively long times with respect to the expected times and with the risk of unwanted contaminations of the ground or air in the medium and long term.

### SUMMARY OF THE INVENTION

The aim of the present invention is to provide a sheet for packaging food that is capable of obviating the limitations of known types of sheet.

Within this aim, an object of the present invention is to provide a sheet for packaging food that is biodegradable and compostable and whose degradation occurs in much shorter times than current sheets of the known type.

Another object of the invention is to provide a sheet for packaging food that is capable of degrading without releasing pollutants and contaminants in the medium and long term.

Another object of the invention is to provide a sheet which, in addition to being impermeable, ensures protection against the light and infrared rays to the packaged food, but also provides assurance of lack of migration of the aluminum from said sheet.

Another object of the present invention is to provide a sheet for packaging food that is capable of ensuring better preservation over time of the organoleptic characteristics and of the freshness and appearance of the packaged food.

Another object of the present invention is to provide a sheet for packaging food that can be produced economically with known systems and technologies.

This aim and these and other objects, which will become better apparent hereinafter, are achieved by a sheet for packaging food, comprising
a first layer made of paper-like material,
a second intermediate layer made of metallic material,
a third layer made of plastic material, on which said second layer is deposited so as to adhere,
an adhesive layer between the first and second layers,
   characterized in that said third layer is constituted by a film of biodegradable and compostable plastic material adapted for contact with food.

### BRIEF DESCRIPTION OF THE DRAWINGS

Further characteristics and advantages of the invention will become better apparent from the following detailed description of a preferred but not exclusive embodiment of the sheet for packaging food according to the invention, illustrated by way of non-limiting example in the accompanying drawing, wherein the sole Figure is a sectional side view of a sheet for packaging food according to the invention.

### DESCRIPTION OF THE PREFERRED EMBODIMENTS

With reference to the figure, a sheet for packaging food according to the invention is generally designated by the reference numeral 10.

The sheet 10 comprises
a first layer 11 made of paper-like material, to be directed outward;
a second intermediate layer 12 made of metallic material, as a barrier against light and the infrared;
a third layer 13 made of plastic material, on which the second layer 12 is deposited,
an adhesive layer 14 between the first layer 11 and the second layer 12.

The particularity of the sheet 10 according to the invention resides in that the third layer 13 is constituted by a film of biodegradable and compostable plastic material adapted for contact with food.

In particular, such film of biodegradable and compostable material is provided by means of a mixture (blend) that comprises
a polymer based on a biodegradable and compostable copolyester of petrochemical origin, such as for example ECOFLEX® F B X 7011 of the BASF company,
a polymer based on polylactic acid of vegetable origin, for example of the type provided by the BASF company.

Such film of biodegradable and compostable plastic material is constituted by a mixture (blend) which is constituted for example by the ECOVIO®/LBX 8145 product of the BASF company.

Such a mixture allows to comply with the DIN38412 part 30 standard related to the non-toxicity of the wastewater produced by composting the biodegradable film.

The third layer 13 thus provided is biodegradable and compostable in less than one hundred and eighty days, as per European standard EN13432 part 2.

The third layer 13, constituted by a film of biodegradable and compostable plastic material, preferably has a density of 1.25±0.1 g/cm³.

The third layer 13 preferably has a minimum thickness of 8 microns, with a grammage of approximately 10 g/m².

The third layer 13 preferably has a maximum thickness of 18 microns, with a grammage of approximately 22.5 g/m².

It is to be understood that the third layer 13 can also be provided by means of films composed of other mixtures of biodegradable polymers which are compostable and suitable for contact with food, for example with mixtures which comprise mostly polymers of vegetable origin, and therefore, weight for weight, adapted to generate a lower CO₂ emission with respect to a polyethylene film, as in known types of sheet.

The third layer 13 can be provided by a mixture that also comprises other additives designed to modify the color and technical characteristics, maintaining in any case its biodegradability, compostability and suitability for contact with food.

The first layer 11 made of paper-like material is preferably made of food-grade or recycled pure cellulose paper, with a grammage comprised between 15 g/m² and 88 g/m².

As an alternative, the first layer 11 made of paper-like material is provided by means of paper of the so-called Kraft and/or recycled Kraft type, i.e., a paper obtained by means of a soda-based process also known as Kraft process, to extract chemically cellulose from wood.

Characteristic, distinctive or ornamental markings, according to the needs and requirements of the retailer, can be printed on the outer face 15 of the first layer 11.

The second intermediate layer 12 made of metallic material is constituted by a thin layer of metallic vapors, which is deposited so as to adhere to the third layer 13.

Such metallic vapors are preferably aluminum vapors.

Such metallization of the third layer 13 reduces its permeability to gases and to water vapor.

The adhesive layer 14 is such as to allow easy manual separation of the first layer 11 from the second layer 12 and the third layer 13.

Such adhesive layer is preferably based on non-toxic, biodegradable and compostable material, for example based on vegetable starches and glucose.

The total weight of the sheet 10 according to the invention is comprised between 25 g/m² and 95 g/m².

In practice it has been found that the invention achieves the intended aim and objects.

The invention has in fact provided a sheet for packaging food which is biodegradable and compostable and whose degradation occurs in much shorter times than similar sheets of the known type, thanks to the film that constitutes the third layer 13, which is made of a mixture of particularly biodegradable and compostable materials.

Further, the invention provides a sheet for packaging food that can degrade without releasing pollutants and contaminants in the medium and long term.

Moreover, the invention provides a sheet which in addition to being impermeable ensures that the packaged foods are protected against the light and infrared rays and also provides assurance of no migration of aluminum from the sheet itself.

Moreover, the present invention provides a sheet for packaging food which is capable of ensuring a better preservation over time of the organoleptic characteristics and of the freshness and appearance of the packaged food.

Moreover, the present invention provides a sheet for packaging food that can be manufactured cheaply with known systems and technologies.

The invention thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. PD2008A000368 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-9. (canceled)

10. A sheet for packaging food, comprising
a first layer made of paper-like material,
a second intermediate layer made of metallic material,
a third layer made of plastic material, on which said second layer is deposited,
an adhesive layer between the first and second layers, wherein said third layer is constituted by a film of biodegradable and compostable plastic material adapted for contact with food made of a mixture that comprises
a polymer based on a biodegradable and compostable copolyester of petrochemical origin,
a polymer based on polylactic acid of vegetable origin.

11. The sheet according to claim 10, wherein said third layer, constituted by a film of biodegradable and compostable plastic material, has a density of 1.25±0.1 g/cm³.

12. The sheet according to claim 10, wherein said third layer has a minimum thickness of 8 microns, with a grammage of approximately 10 g/m², and a maximum thickness of 18 microns, with a grammage of approximately 22.5 g/m².

13. The sheet according to claim 10, wherein said third layer is provided by a mixture that also comprises additives designed to modify the color and technical characteristics, maintaining its biodegradability, compostability and suitability for contact with food.

14. The sheet according to claim 10, wherein said first layer made of paper-like material is made of food-grade or recycled pure cellulose paper, with a grammage comprised between 15 g/m² and 88 g/m².

15. The sheet according to claim 10, wherein said first layer made of paper-like material is provided by means of paper of the so-called Kraft or recycled Kraft type.

16. The sheet according to claim 10, wherein said second intermediate layer made of metallic material is constituted by a thin layer of metallic vapors, deposited on said third layer.

17. The sheet according to claim 10, wherein said adhesive layer is such as to allow easy manual separation of the first layer from the second layer and the third layer and is, for example, based on vegetable starches and glucose.

18. The-sheet according to claim 10, having a total weight comprised between 25 g/m² and 95 g/m².
